(19) United States
(12) Patent Application Publication
(10) Pub. No.: US 2009/0196362 A1
(43) Pub. Date: Aug. 6, 2009

(54) TRANSMISSION METHOD AND APPARATUS FOR ALLOCATING SUBCHANNEL AND FORMING STATIONARY BEAM TO MAXIMIZE TRANSMISSION EFFICIENCY IN ORTHOGONAL FREQUENCY DIVISION MULTIPLEXING/MULTIPLE ACCESS BASED WIRELESS COMMUNICATION SYSTEM

(76) Inventors: Myung-Sun Song, Daejeon-city (KR); Sung-Hyun Hwang, Suwon-city (KR); Gwang-Zeen Ko, Seoul (KR); Kyung-Hi Chang, Seoul (KR); Sung-Ho Park, Seoul (KR); Sang-Jun Ko, Seoul (KR); Joo Heo, Incheon-city (KR); Jung-Ju Kim, Incheon-city (KR)

Correspondence Address: LADAS & PARRY LLP, 224 SOUTH MICHIGAN AVENUE, SUITE 1600, CHICAGO, IL, 60604, US

(21) Appl. No.: 12/304,291

(22) PCT Filed: Sep. 28, 2006
(86) PCT No.: PCT/KR2006/003876

§ 371 Date: Dec. 11, 2008

(30) Foreign Application Priority Data
Jun. 26, 2006 (KR) 10-2006-0057629

(51) Int. Cl. H04L 27/28

(52) U.S. Cl. 375/260

(57) ABSTRACT

Provided are a transmission method and apparatus for allocating a subchannel and forming a stationary beam to maximize transmission efficiency in an OFDMA based wireless communication system. The method includes determining the subchannel for the equipment of each user based on the channel state of the equipment of each user, determining a beam index for the equipment of each user, based on location information and direction of arrival information of the equipment of each user, generating an OFDM symbol by mapping a modulation symbol corresponding to the equipment of each user to the determined subchannel, and transmitting the generated OFDM symbol to a wireless space by forming a beam following the determined beam index. Using the method, the equipment of each user can be allocated with an advantageous subchannel, can remove an interference signal at low cost, and can increase total throughput of an OFDMA system downlink.

### TECHNICAL FIELD

The present invention relates to a transmission method and apparatus in an orthogonal frequency division multiplexing/multiple access (OFDMA) system, and more particularly, to a transmission method and apparatus which dynamically allocates a subchannel and which transmits an orthogonal frequency division multiplexing (OFDM) symbol using an array antenna in an OFDMA system.

### BACKGROUND ART

Compared to a wire communication system, a wireless communication system has an inferior environment and there are a lot of disturbances. The main reasons for performance deterioration in wireless communication include co-channel interference signals occurring between cells or inside a cell, multi-path fading, the Doppler effect due to transferring speed, etc. Methods to compensate for the above reasons, so as to improve the performance of wireless communication systems, have been studied, such as power control, channel coding, transmission/reception diversity method, frequency multiplexing, band spreading, etc. However, although the demand for a better and more varied service in wireless communication systems has increased, the requirement for large, high quality data transmission cannot be satisfied using conventional methods only. Accordingly, research on systems beyond IMT-2000 and 4^{th} generation mobile communication systems is being carried out in order to support multimedia services which require super speed packet transmission while securing a high data transmission rate and various quality of service (QoS) levels. Also, wireless broadband internet (WiBro) or next generation wireless communication systems, which transmit data quicker than IMT-200 and 4^{th} generation mobile communication systems, are targeted to provide data quickly and cheaply. To obtain a high transmission rate from among the requirements of a 4^{th} generation mobile communication system, robust properties in a wireless channel having a multi-path fading characteristic are required. Also, a burst data transmission property and a good granularity property are required as a service changes from circuit-oriented to packet-oriented.

Owing to its high transmission efficiency and its simple channel equalizing method, an OFDM method is one method that can be applied to 4^{th} generation mobile communication systems. Also, an OFDMA method, which is a multi-user access method based on OFDM allocating a different subcarrier to each user, can provide various QoS levels by allocating various resources based on a user's request. The OFDM method is a standard physical layer of the IEEE 802.16a standard, and is selected as a wireless access method for a superspeed mobile internet in Korea.

However, the OFDM method has been applied in a wire system, such as Asymmetric Digital Subscriber Line (ADSL) or very high bit rate DSL (VDSL), and a wireless system which isn't very mobile, such as a wireless LAN (WLAN). Accordingly, to apply the OFDM method in cellular communication, research in various fields needs to be performed.

The OFDM method has high frequency efficiency, can compensate for an increase in inter-symbol interference during high speed transmission due to a simple single tap equalizer, and uses a fast Fourier transform (hereinafter, referred to as FFT) to achieve high speed. Accordingly, the OFDM method has been employed in recent high speed data wireless communications, such as wireless LAN, broadband wireless access (BWA), digital audio broadcasting (DAB), digital video broadcasting (DVB), ADSL, VDSL, etc. However, to use the OFDM method in cellular communication, much research needs to be carried out, such as research on a cell planning method for increasing the coverage of an OFDMA cellular system and research on a resource allocation algorithm for increasing cell capacity by efficiently managing wireless resources. Also, research on link adaptation, such as dynamic channel allocation and dynamic power allocation, and an adaptive modulation method is required using a user's channel information. In cellular communication, an important factor determining performance of an OFDMA based system is a frequency reuse factor. When a frequency reuse rate is 1, a base station can use all wireless resources, which is ideal in terms of throughput of the base station. However, serious performance deterioration may occur due to intra cell interference.

Accordingly, to implement a frequency reuse rate of 1 while solving performance deterioration caused by intra cell interference, a Flash-OFDM system developed by Flarion uses a frequency hopping method which converts a subcarrier of OFDM into a regular pattern, and uses a low density parity check (LDPC) channel symbol to prevent performance deterioration caused by intra cell interference. Aside from this, a method of perforating a subcarrier randomly in order to reduce collision between an adjacent cell and subcarrier is being studied.

In the case of a system maintaining a frequency reuse of 1, as traffic overload increases, performance deteriorates in a cell boundary having inferior channel states due to intra cell interference. Accordingly, in order to reduce intra cell interference, improve frequency efficiency, and guarantee performance of a user located in a position having an inferior state, such as a cell boundary, a wireless resources allocation method for efficiently using limited frequency resources is being studied. When a channel is stationary and a transmitting end knows the exact channel response of a user, a combined method of a water-filling method and an adaptive modulation method is the optimal method for system efficiency. A water-filling method has been mainly studied in single user system or multi-user system supporting stationary resource allocation. For example, a system using time division multiple access (TDMA) or frequency division multiple access (FDMA) allocates a predetermined time slot or frequency channel for each user, and then applies an adaptive modulation method to the channels used by each user. However, a multi-user OFDM method applying the adaptive modulation method based on stationary resource allocation cannot allocate the optimum resource that the actual system can provide. The reason for this is that, based on properties of frequency selective channel, there are subchannels under deep fading states or subchannels that are difficult to allocate a lot of power to, thereby generating unused channels when a water-filling method is applied. Also, when the OFDM method is applied to a conventional antenna technology transmitting signals in all directions, a device receiving the signals cannot achieve excellent reception due to interference signals from other devices.

### DISCLOSURE OF INVENTION

### Technical Problem

The present invention provides an OFDMA based transmission method and apparatus which can allocate subchannels suitable for each device and which can remove interference signals at low cost.

The present invention also provides an OFDMA based transmission method and apparatus which can allocate subchannels suitable for each device, which can remove interference signals at low cost, which can satisfy a Quality of Service (QoS), and which is power effective.

### Technical Solution

According to an aspect of the present invention, there is provided a method of allocating a subchannel and forming a stationary beam to maximize transmission efficiency in an OFDMA based wireless communication system, the method including: determining a subchannel for equipment of each user based on channel state of the equipment of each user; determining a beam index for the equipment of each user, based on location information and direction of arrival information of the equipment of each user; generating an OFDM symbol by mapping a modulation symbol corresponding to the equipment of each user to the determined subchannel; and transmitting the generated OFDM symbol to a wireless space by forming a beam following the determined beam index.

The method may further include calculating a predicted received signal to interference noise ratio of the equipment of each user, based on the channel state of the determined subchannel and determined beam index and determining a modulation and coding scheme level for the equipment of each user, based on the calculated predicted received signal to interference noise ratio, wherein the generating of the OFDM symbol comprises performing modulation and coding based on the determined modulation and coding scheme level.

The method may further include calculating a predicted received signal to interference noise ratio of the equipment of each user, based on the channel state of the determined subchannel and determined beam index and determining a modulation and coding scheme level and allocated power of the equipment of each user, based on the calculated predicted received signal to interference noise ratio, wherein the generating of the OFDM symbol comprises performing modulation and coding based on the determined modulation and coding scheme level and regulating a size value of each modulation symbol based on the determined allocated power.

The determining of the subchannel may include determining a subchannel having the most superior channel state from among subchannels not yet allocated as a subchannel for the equipment of each user, based on the channel state of the equipment of each user, following a sequence of the equipment of each user having the smallest ratio of the allocated amount of data to requested amount of data.

According to another aspect of the present invention, there is provided an apparatus for allocating a subchannel and forming a stationary beam to maximize transmission efficiency in an OFDMA based wireless communication system, the apparatus including: a subchannel determining unit determining a subchannel for the equipment of each user, based on a channel state of the equipment of each user; a beam index determining unit determining a beam index for the equipment of each user, based on location information and direction of arrival information of the equipment of each user; an OFDM symbol generating unit generating an OFDM symbol by mapping a modulation symbol corresponding to the equipment of each user to the determined subchannel; and an OFDM symbol transmitting unit transmitting the generated OFDM symbol to a wireless space by forming a beam following the determined beam index.

The apparatus may further include a parameter determining unit calculating a predicted received signal to interference noise ratio of the equipment of each user, based on the channel state of the determined subchannel and the determined beam index and determining a modulation and coding scheme level for the equipment of each user based on the calculated predicted received signal to interference noise ratio, wherein the OFDM symbol generating unit performs modulation and coding based on the determined modulation and coding scheme level.

The apparatus may further include a parameter determining unit calculating the predicted received signal to interference noise ratio of the equipment of each user, based on the channel state of the determined subchannel and the determined beam index and determining a modulation and coding scheme level and allocated power of the equipment of each user, based on the calculated predicted received signal to interference noise ratio, wherein the OFDM symbol generating unit performs modulation and coding based on the determined modulation and coding scheme level and regulates a size value of each modulation symbol based on the determined allocated power.

The subchannel determining unit may determine a subchannel having the most superior channel state from among subchannels not yet allocated as a subchannel for the equipment of each user, based on the channel state of the equipment of each user, following a sequence of the equipment of each user having the smallest ratio of an amount of allocated data to amount of requested data.

### ADVANTAGEOUS EFFECTS

Using the present invention, multi-user diversity gain can be obtained by considering fairness to each user and by not allocating one subchannel to a plurality of users in order to prevent intra cell interference when allocating good channels to each user.

Also, calculation complexity can be remarkably reduced and a beam forming system of a base station can be greatly simplified by applying a stationary beam forming method which takes advantage of a stationary environment. Also, transmission efficiency of a system downlink and outage probability performance can be improved because separate feedback information of a higher link is not required.

In addition, resources can be effectively used and a QoS required by users can be guaranteed by combining a beam forming method and dynamic resource allocation.

### DESCRIPTION OF DRAWINGS

The above and other features and advantages of the present invention will become more apparent by describing in detail exemplary embodiments thereof with reference to the attached drawings in which:

FIG. 1 is a block diagram illustrating a transmission apparatus for allocating a subchannel and for forming a stationary beam in order to maximize transmission efficiency in an OFDMA based wireless communication system according to an embodiment of the present invention;

FIG. 2 is a diagram showing cell planning for an OFDMA platform according to an embodiment of the present invention;

FIG. 3 is a diagram illustrating a structure of a wireless resource which can be used in a sector of the cell illustrated in FIG. 2;

FIG. 4 is a table showing a system parameter of an OFDMA system applied to an embodiment of the present invention;

FIGS. 5A and 5B are diagrams respectively illustrating a first phase and a second phase of an algorithm for best channel selection per user considering fairness, which is a dynamic channel allocation method applied to an embodiment of the present invention; and

FIG. 6 is a flowchart illustrating a transmission method of allocating a subchannel and forming a stationary beam to maximize transmission efficiency in an OFDMA based wireless communication system according to an embodiment of the present invention.

### MODE FOR INVENTION

Hereinafter, the present invention will be described more fully with reference to the accompanying drawings, in which exemplary embodiments of the invention are shown.

As described above, based on the properties of a frequency selective channel, there are subchannels under deep fading states or subchannels that are difficult to allocate a lot of power to, thereby generating unused channels when a water-filling method is applied to a conventional OFDMA system. However, a channel under deep fading states to one user may not appear as a channel under deep fading states to another user, and when the number of users increases, the probability of each subchannel performing OFDM being a channel under deep fading states to all users decreases. That is, as the number of users increases, the users can receive independent channels, thereby obtaining multi-user diversity gain.

A smart antenna method, which is the same as a dynamic resource allocation method, compensates for performance deterioration of a wireless communication system in order to increase the whole system performance. Accordingly, the smart antenna method is known to be the most effective and most commercially viable method to satisfy requests in the communication market.

In a conventional wireless communication system, at least two diversity antennas are used to effectively combine multi-path signals, thereby obtaining diversity gain and improving overall performance. However, the smart antenna method uses arranged antenna and adaptively controls an antenna beam pattern based on a radio frequency (hereinafter, referred to as RF) signal environment by using a digital signal processing method. In other words, unlike a conventional antenna method transmitting a signal to all directions, the smart antenna method minimizes interference signals from other users inside a corresponding cell or sector by forming a direct beam to a required user. Accordingly, communication quality and channel capacity can be increased, and a service radius can broaden. The smart antenna method can be classified into a stationary beam forming method and an adaptive beam forming method. The stationary beam forming method has a relatively simple structure, and is realized by presetting a beam forming direction and a corresponding weight vector and forming a beam while switching to a required user using the preset beam forming direction and the corresponding weight vector. However, the performance of the stationary beam forming method is inferior to that of the adaptive beam forming method. The adaptive beam forming method renews a weight vector while adapting the weight vector based on a location of the required user in order to maximize the ratio of user signal to interference signal. The adaptive beam forming method shows superior performance, but the structure is complicated.

In the present invention, by applying the stationary beam forming method to a dynamic resource allocation method of an OFDMA based system, a transmission apparatus can improve downlink throughput and outage probability performance, compared to when the stationary beam forming method is not applied. The transmission apparatus can satisfy QoS and transmit effectively by further applying dynamic bit allocation and dynamic power allocation. In other words, embodiments of the present invention provide an OFDMA based transmission method and apparatus which can maximize transmission efficiency of a system, keep costs low, have low calculation complexity, and which can reduce interference signals by transmitting an OFDM symbol using the stationary beam forming method after allocating a subchannel that is advantageous to each user, in a multi-user OFDMA system. The OFDMA based transmission method and apparatus can be used in a base station using an OFDM transmission method. Also, other embodiments of the present invention provide an OFDMA based transmission method and apparatus which can increase transmission efficiency of a system and which can achieve a power efficient system by applying the dynamic bit allocation method and the dynamic power allocation method based on a channel state whereby the stationary beam forming method is applied.

The present invention is based on the OFDMA system, and it is assumed that the OFDMA based transmission apparatus is aware of location information and direction of arrival (DoA) information of the equipment of each user. Also, since the stationary beam forming method is applied, the equipment of each user is better than stationary equipment, for example, customer premises equipment (hereinafter, referred to as CPE). In order to allocate an advantageous subchannel for a user, the OFDMA based transmission apparatus should obtain channel state information on each subchannel on the equipment of each user. Various methods of obtaining the channel state information are disclosed in several documents, including a feedback method which will be described later. Accordingly, a detailed description thereof will be omitted at this point.

Hereinafter, an embodiment of the present invention will be described, particularly when an embodiment of the present invention is applied to a base station and CPE. Each base station constructs a database with location information and DoA information on each CPE. This process is performed when a new CPE is added, and the database is used in applying a beam index which indicates a beam forming direction and the corresponding weight vector on the stationary beam forming method. Also, each base station is provided with genuine information about channel state while being unsupported with a stationary beam pattern from CPE. Accordingly, the base station allocates each user with a good channel considering fairness on each CPE. Specifically, to prevent intra cell interference, the base station does not allocate one subchannel to a plurality of CPEs, thereby obtaining multi-user diversity gain. For convenience, an embodiment of the present invention will be described using a best channel selection per user considering fairness method from among dynamic resource allocation methods allocating a subchannel according to a user's circumstances. However, the present invention is not limited thereto and other dynamic resource allocation methods can be used.

Accordingly, the base station predicts a received signal to interference and noise ratio (hereinafter, referred to as SINR) when the stationary beam forming method is applied to each CPE using the stationary beam index for each CPE stored in the database. Then, the base station performs dynamic bit allocation and dynamic power allocation based on the predicted received SINR.

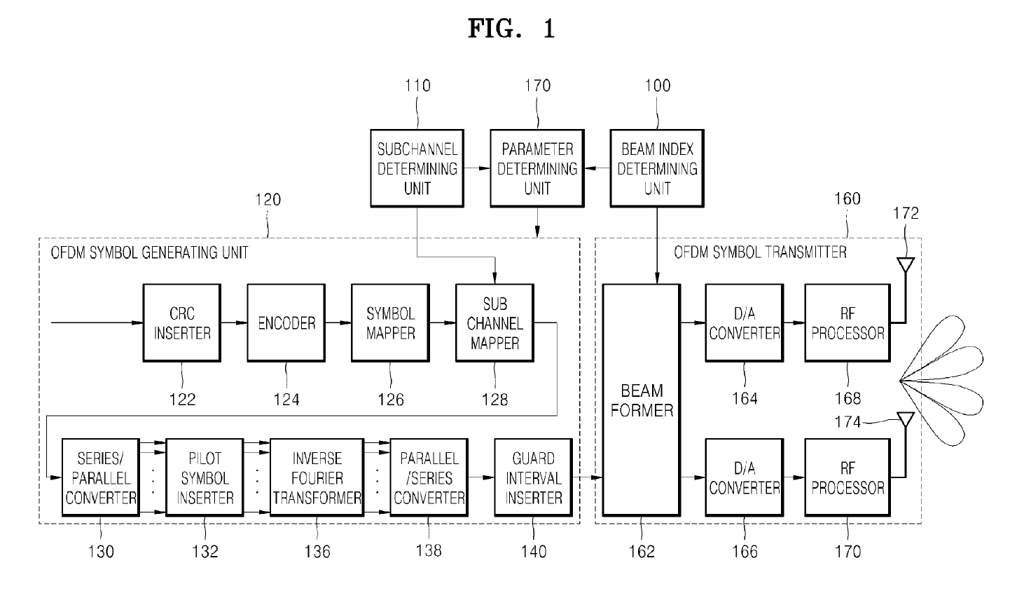

FIG. 1 is a block diagram illustrating a transmission apparatus for allocating a subchannel and for forming a stationary beam in order to maximize transmission efficiency in an OFDMA based wireless communication system according to an embodiment of the present invention.

Referring to FIG. 1, the transmission apparatus includes a beam index determining unit 100, a subchannel determining unit 110, an OFDM symbol generating unit 120, an OFDM symbol transmitting unit 160, and a parameter determining unit 170.

The beam index determining unit 100 determines a beam index of the equipment of each user, based on location information and DoA information on the equipment of each user. Here, the OFDMA based transmission apparatus according to the current embodiment can perform the determination of a beam index by constructing a database for storing the location information and DoA information. Preferably, the beam index determining unit 100 may include the database.

An example of constructing the database is when a user installs equipment or turns on equipment, the equipment transmits its location index to a base station which supplies service to the equipment, accordingly the base station stores a database after obtaining location information and DoA information based on the received location index. Here, the stored location information and DoA information are used to determine a beam index.

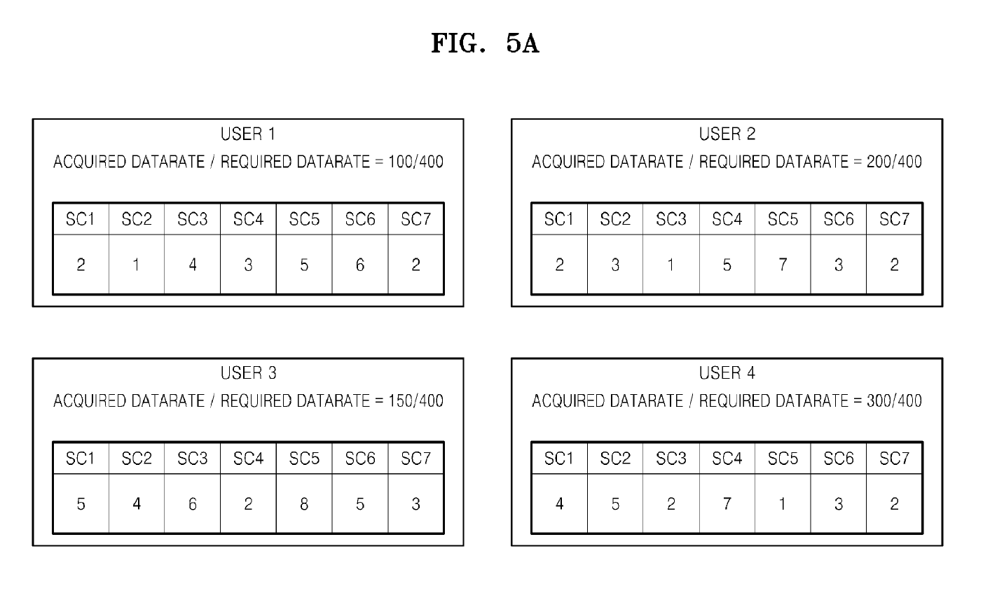

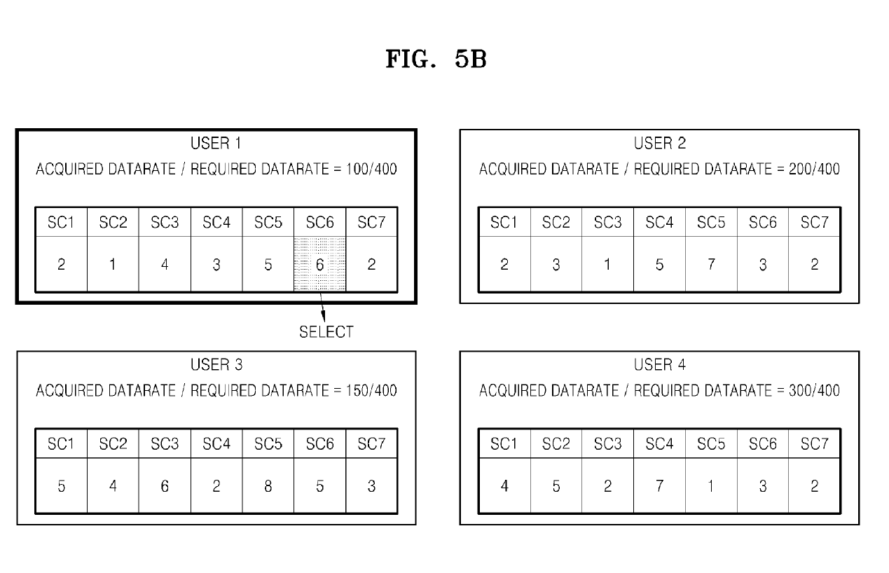

The subchannel determining unit 110 determines a subchannel for the equipment of each user, based on a channel state of the equipment of each user. Here, the channel state is the SINR on each subchannel where stationary beam forming (hereinafter, referred to as SBF) is not applied. An example of a method of a base station obtaining information about the channel state includes a method of the equipment of each user calculating the SINR using a downlink preamble and feedback information on the calculated SINR to the base station. An example of a method of determining a subchannel includes, as described above, a best channel selection per user considering fairness method. According to the best channel selection per user considering fairness method, the subchannel determining unit 110 determines a subchannel having the most superior channel state from among subchannels not yet allocated as a subchannel for the equipment of each user, based on a channel state of the equipment of each user, following a sequence of the equipment of each user having the smallest ratio of the amount of allocated data to amount of requested data. A detailed description will follow later referring to FIGS. 5A and 5B.

The OFDM symbol generating unit 120 generates an OFDM symbol including at least one information data bit which is to be transmitted to the equipment of each user positioned at the determined subchannel. Referring to FIG. 1, the OFDM symbol generating unit 120 includes a cyclic redundancy check (CRC) inserter 122, an encoder 124, a symbol mapper 126, a subchannel mapper 128, a series/parallel converter 130, a pilot symbol inserter 132, an inverse Fourier transformer 136, a parallel/series converter 138, and a guard interval inserter 140.

The CRC inserter 122 inserts CRC code in an information data bit. The encoder 124 performs channel coding using the output from the CRC inserter 122. The channel coding may be determined by a channel code and a code rate. Examples of channel code include low-density parity-check (LDPC), convolutional code, and turbo code, but are not limited thereto. A binary stream is input into the symbol mapper 126. The symbol mapper 126 converts the inputted binary stream to at least one modulation symbol according to a modulation scheme such as a Q-PSK modulation scheme (quadrature-phase shift keying modulation, hereinafter, referred to as PSK), a 8-PSK modulation scheme, or a 16-QAM (quadrature amplitude modulation, hereinafter, referred to as QAM) scheme.

The subchannel mapper 128 allocates the modulation symbols corresponding to the equipment of each user to a subchannel determined in the subchannel determining unit 110 in order to supply the modulation symbols to the series/parallel converter 130.

The series/parallel converter 130 outputs the modulation symbols in parallel, and the pilot symbol inserter 132 inserts pilot symbols into a plurality of modulation symbols.

The inverse Fourier transformer 136 applies an inverse Fourier transform calculation, such as an inverse fast Fourier transform, etc., to the output of the series/parallel converter 130. The parallel/series converter 138 outputs the inverse Fourier calculation results in series. The guard interval inserter 140 inserts a guard interval, such as a cyclic prefix, to the output of the parallel/series converter 138 in order to finally generate an OFDM symbol.

The OFDM symbol transmitting unit 160 transmits the OFDM symbol to a wireless space by forming a beam following the determined beam index in the beam index determining unit 100. Referring to FIG. 1, the OFDM symbol transmitting unit 160 includes a beam former 162, D/A converters 164 and 166, RF processors 168 and 170, and transmission antennas 172 and 174.

The beam former 162 signal-processes the OFDM symbol in a beam forming pattern that corresponds to the determined beam index in order to generate a number of signals which is the same as a number of transmission antennas and supplies the generated signals to both the D/A converters 164 and 166. The signals are converted into analog signals by the D/A converters 164 and 166, and then converted into radio frequency signals by the RF processors 168 and 170. Accordingly, the radio frequency signals are transmitted to wireless space by transmission antennas 172 and 174.

According to another embodiment of the present invention, the transmission apparatus further includes a parameter determining unit 170 as shown in FIG. 1. The parameter determining unit 170 determines a modulation and coding scheme level for dynamic bit allocation and also determines power value that will be allocated to the equipment of each user for additional dynamic power allocation.

Hereinafter, the determination of a modulation and coding scheme level for dynamic bit allocation will be described. The parameter determining unit 170 calculates predicted SINR of the equipment of each user based on a channel state that corresponds to the determined subchannel and the determined beam index, and then determines a modulation and coding scheme level for the equipment of each user based on the calculated predicted SINR. Here, the predicted SINR is a received SINR after beam forming is applied. Accordingly, the predicted SINR generally has a higher value compared to a received SINR included in the channel state information. Examples of parameters determined by the determined modulation and coding scheme include a coding parameter including a code rate, types of channel code, etc. and a modulation parameter including a modulation level, such as BPSK, QAM, 16-QAM, etc., a modulation method, etc. In other words, based on the modulation and coding scheme level determined by the parameter determining unit 170, the encoder 124 of the OFDM symbol generating unit 120 performs channel coding based on the corresponding coding parameter and the symbol mapper 126 performs symbol mapping based on the corresponding modulation parameter. The above process corresponds to the dynamic bit allocation. Specifically when dynamic power allocation, which will be described below, is not performed, the OFDM symbol generating unit 120 uniformly allocates power to each subchannel.

Next, dynamic power allocation will be described. The parameter determining unit 170 classifies the equipment of each user into a first group and a second group. Here, the first group is formed of equipment allocated with a larger amount of data than the amount of requested data, and the second group is formed of equipment allocated with a smaller amount of data than the amount of requested data. Next, the parameter determining unit 170 renews the modulation and coding scheme level so that the amount of data allocated to the first group is approximate to the amount of requested data. Also, the parameter determining unit 170 removes surplus power from among the allocated power using a method of uniformly allocating power to all frequency domains of the OFDM symbol, exceeding requested power according to the renewed modulation and coding scheme level and the quality of service (QoS) of the equipment of each user. Here, examples of QoS include bit error rate, symbol error rate, etc. The received SINR which is requested to satisfy the QoS required by each user can be calculated based on the modulation and coding scheme level and the QoS. Also, surplus power can be calculated based on the calculated received SINR and the allocated power. Next, the parameter determining unit 170 additionally allocates the surplus power to the uniformly allocated power of the subchannels corresponding to the second group and then renews the modulation and coding scheme level so that the amount of data approximate to the amount of requested data is allocated using the increased power. On the other hand, the encoder 124 of the OFDM symbol generating unit 120 performs channel coding based on the coding parameter corresponding to the renewed modulation and coding scheme level. The symbol mapper 126 performs symbol mapping based on the corresponding modulation parameter, and the OFDM symbol generating unit 120 regulates the size value of the modulation symbol positioned at each subcarrier based on the allocated power. Regulating of the size value of the modulation symbol may be performed in the symbol mapper 126, subchannel mapper 128, series/parallel converter 130, etc.

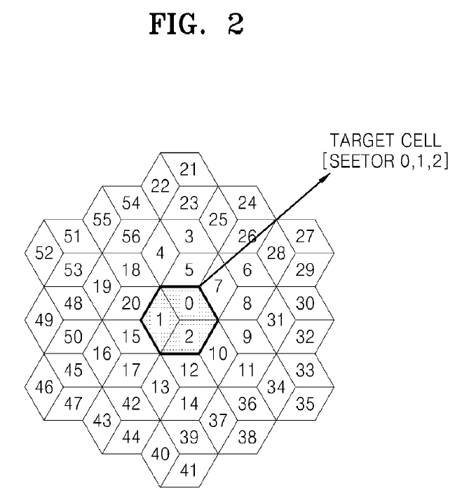

FIG. 2 is a diagram showing cell planning for an OFDMA platform according to an embodiment of the present invention. Considering a hexagonal cell structure, each cell is formed of three sectors. As a whole, there are 57 sectors and each sector has a base station. A target cell in the middle is formed of three sectors 0, 1, and 2. The sectors 0, 1, and 2 are each interfered by another 54 sectors around them.

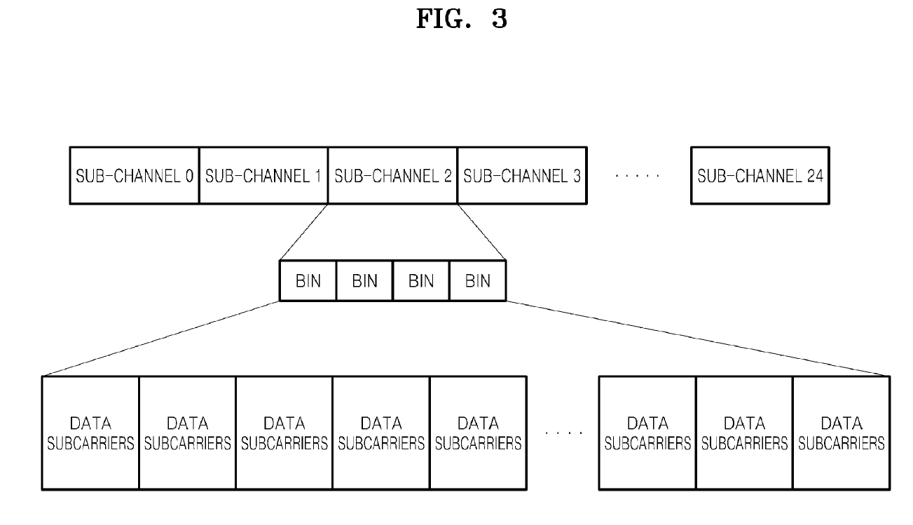

FIG. 3 is a diagram illustrating a structure of a wireless resource which can be used in a sector of the cell illustrated in FIG. 2. In the frequency domain, the whole band is formed of 24 subchannels, and each subchannel is formed of 4 BIN. Each BIN is formed of 15 consecutive subcarriers, and one subcarrier from among the 15 consecutive subcarriers may be used as a pilot subcarrier which can be used in channel estimation, SINR measurement, etc. Also, the initial transmission power of each subcarrier is presumed to be uniformly fixed. The users feedback the average SINR of all subchannels to the base station that each subchannel belongs to. Accordingly, multi-user diversity gain can be obtained by the base station of each sector allocating subchannels having good SINR to the users based on the feedback information.

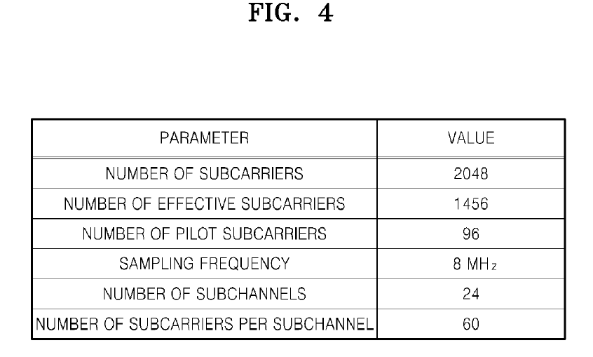

FIG. 4 is a table showing a system parameter of an OFDMA system applied to an embodiment of the present invention. The whole band is formed of a total of 2048 subcarriers. From among them, 1450 subcarriers are used and 1360 subcarriers are effective subcarriers excluding 96 pilot subcarriers. A sampling frequency is 8 MHz, each subchannel is formed of 60 consecutive subcarriers, and 4 subcarriers from among the 60 consecutive subcarriers are pilot subcarriers.

FIGS. 5A and 5B are diagrams respectively illustrating a first phase and a second phase of an algorithm of best channel selection per user considering fairness, which is a dynamic channel allocation method applied to an embodiment of the present invention. Hereinafter, the first phase will be described referring to FIG. 5A. In order to allocate a channel to a user, the ratio of the sum total of the acquired transmission data rate the user received until then to the required transmission data rate is calculated. That is, the ratio of the sum total of the acquired transmission data rate user 1 received until then to the required transmission data rate is 100/400, the ratio of the sum total of the acquired transmission data rate user 2 received until then to the required transmission data rate is 200/400, the ratio of the sum total of the acquired transmission data rate user 3 received until then to the required transmission data rate is 150/400, and the ratio of the sum total of the acquired transmission data rate user 4 received until then to the required transmission data rate is 300/400.

Referring to FIG. 5B, the second phase will now be described. In the second phase, system fairness is maintained by preferentially allocating a channel to the user having the smallest ratio of the sum total of the acquired transmission data rate the user received until then to the required transmission data rate in the first phase. At this time, the user who is determined to be allocated a channel is allocated a subchannel which guarantees the highest received SINR from among the user's own subchannels. Referring to FIG. 5A, user 1 has the smallest ratio of the sum total of the acquired transmission data rate the user received until then to the required transmission data rate, which is 100/400. Accordingly, the user which will be allocated the subchannel is user 1. The base station allocates user 1 the sixth subchannel because from among the subchannels of user 1, and the received SINR of the sixth subchannel is the highest with a value of 6. As such, the first and second phases are repeated to allocate each user with a channel.

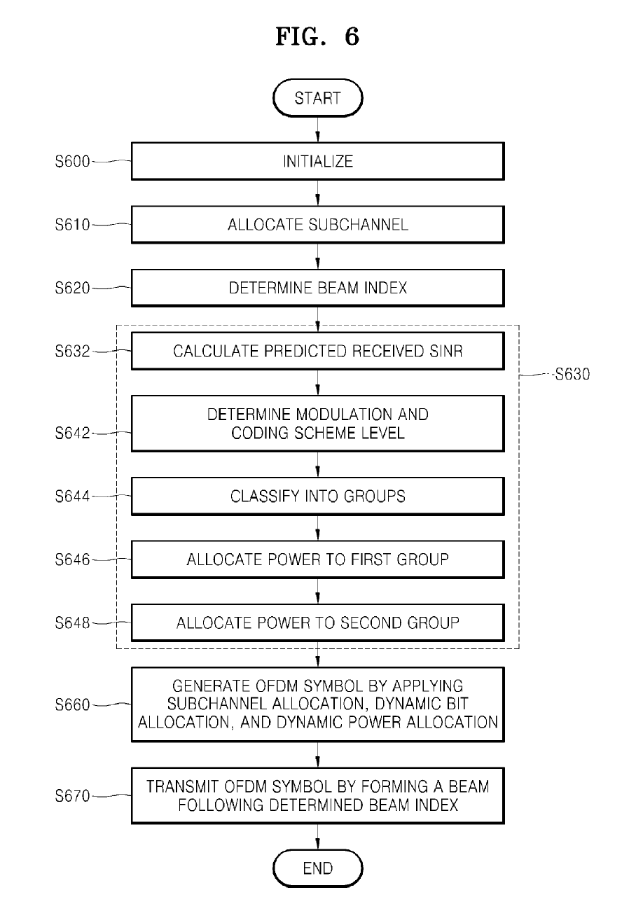

FIG. 6 is a flowchart illustrating a transmission method for allocating a subchannel and forming a stationary beam to maximize transmission efficiency in an OFDMA based wireless communication system according to an embodiment of the present invention.

Referring to FIG. 6, the OFDMA based transmission method according to the current embodiment of the present invention is formed of time sequential operations performed by the OFDMA based transmission apparatus of FIG. 1. Accordingly, even if some descriptions are omitted, the descriptions of the OFDMA based transmission apparatus illustrated in FIG. 1 can be applied to the OFDMA based transmission method.

In operation S600, basic parameters of the OFDMA based transmission apparatus are initialized. Here, examples of parameters which are initialized include an initial power value which is allocated to each subchannel, location information on equipment of each user, the direction of arrival information of equipment of each user, etc. Location information and direction of arrival information can be obtained, for example, when a user installs equipment or turns on equipment, at which point the equipment transmits its location index to a base station. Based on the received location index, the OFDMA based transmission apparatus obtains location information and the direction of arrival information and stores obtained information in a database.

In operation S610, the subchannel determining unit 110 allocates a subchannel to the equipment of each user by performing the above described dynamic channel allocation using channel state information of each subchannel supplied periodically by the equipment of each user. That is, the equipment of each user calculates a genuine SINR of all subchannels when a stationary beam forming method is not applied, using downlink preamble, and feeds back channel state information including the calculated SINR to the OFDMA based transmission apparatus.

In operation S620, the beam index determining unit 100 determines a beam index based on location information and direction of arrival information stored in the database.

In operation S630, the parameter determining unit calculates a predicted received SINR when the stationary beam forming method is applied to the determined subchannel based on the channel state of the determined subchannel and the determined beam index, and then performs dynamic bit allocation and dynamic power allocation to the determined subchannel of the equipment of each user based on the calculated predicted received SINR.

In operation S660, the OFDM symbol generating unit 120 applies channel coding and modulation that corresponds to the dynamic bit allocation on information data of the equipment of each user, then regulates the modulated symbol to a size value which corresponds to the allocated power, and then generates an OFDM symbol by recording the regulated symbol on the determined subchannel.

In operation S670, the OFDM symbol transmitting unit 160 transmits the generated OFDM symbol by forming a beam following the determined beam index to a wireless space.

Referring to FIG. 6, operation S630 includes calculating a predicted received SINR in operation S632, determining a modulation and coding scheme level in operation S642, classifying equipment into groups in operation S644, allocating power to a first group in operation S646, and allocating power to a second group in operation S648. Specifically, when dynamic power allocation is not performed in operation S630, power may be uniformly allocated to each subchannel in operation S642 using the power initialized in operation S600. Accordingly, operations S644 to S648 may be omitted.

In operation S632, the parameter determining unit 170 calculates the predicted received SINR when the stationary beam forming method is applied to the determined subchannel based on the channel state of the determined subchannel and the determined beam index.

In operation S642, the parameter determining unit 170 determines a modulation and coding scheme level of the equipment of each user based on the calculated predicted received SINR.

In operation S644, the parameter determining unit 170 classifies the equipment of each user into a first group and a second group based on the determined modulation and coding scheme level. Here, the first group is formed of equipment allocated with an amount of data more than the amount of requested data, and the second group is formed of equipment allocated with an amount of data less than the amount of requested data.

In operation S646, the parameter determining unit 170 renews the modulation and coding scheme level so that the amount of data allocated to the first group is approximate to the amount of requested data. Also, the parameter determining unit 170 removes surplus power from among the allocated predetermined power applied to the determined subchannel of the equipment of each user, exceeding requested power according to the renewed modulation and coding scheme level and the QoS required by the equipment of each user. Here, an example of predetermined power may be the power required to transmit one OFDM symbol divided the number of subchannels or subcarriers.

In operation S648, the parameter determining unit 170 additionally allocates the surplus power to the uniformly allocated power of subchannels corresponding to the second group and then renews the modulation and coding scheme level so that the amount of data approximate to the amount of requested data is allocated using the increased power.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Functional programs, codes, and code segments which embody the present invention are obvious to programmers in the related art.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

Using the present invention, multi-user diversity gain can be obtained by considering fairness to each user and by not allocating one subchannel to a plurality of users in order to prevent intra cell interference when allocating good channels to each user.

Also, calculation complexity can be remarkably reduced and a beam forming system of a base station can be greatly simplified by applying a stationary beam forming method which takes advantage of a stationary environment. Also, transmission efficiency of a system downlink and outage probability performance can be improved because separate feedback information of a higher link is not required. In addition, resources can be effectively used and a QoS required by users can be guaranteed by combining a beam forming method and dynamic resource allocation.

1. A method of allocating a subchannel and forming a stationary beam to maximize transmission efficiency in OFDMA based wireless communication system, the method comprising:
determining a subchannel for equipment of each user based on channel state of the equipment of each user;
determining a beam index for the equipment of each user, based on location information and direction of arrival information of the equipment of each user;
generating an OFDM symbol by mapping a modulation symbol corresponding to the equipment of each user to the determined subchannel; and
transmitting the generated OFDM symbol to a wireless space by forming a beam following the determined beam index.

2. The method of claim 1, further comprising calculating a predicted received signal to interference noise ratio of the equipment of each user, based on the channel state of the determined subchannel and determined beam index and determining a modulation and coding scheme level for the equipment of each user, based on the calculated predicted received signal to interference noise ratio, wherein the generating of the OFDM symbol comprises performing modulation and coding based on the determined modulation and coding scheme level.

3. The method of claim 1, further comprising calculating a predicted received signal to interference noise ratio of the equipment of each user, based on the channel state of the determined subchannel and determined beam index and determining a modulation and coding scheme level and allocated power of the equipment of each user, based on the calculated predicted received signal to interference noise ratio,
wherein the generating of the OFDM symbol comprises performing modulation and coding based on the determined modulation and coding scheme level and regulating a size value of each modulation symbol based on the determined allocated power.

4. The method of claim 3, wherein the determining of the modulation and coding scheme level and allocated power comprises:
determining a modulation and coding scheme level for the equipment of each user, based on the calculated predicted received signal to interference noise ratio;
classifying the equipment of each user into a first group, formed of equipment allocated an amount of data which exceeds an amount of requested data, and a second group, formed of other equipment, based on the determined modulation and coding scheme level;
renewing the modulation and coding scheme level on the equipment of each user in the first group so that an amount of data approximate to the amount of requested data is allocated, and removing surplus power from the predetermined power allocated to the determined subchannel which exceeds requested power based on the renewed modulation and coding scheme level and quality of service (QoS) required by the equipment of each user; and
allocating the surplus power to the determined subchannel allocated with the predetermined power on the equipment of each user in the second group, and
renewing the modulation and coding scheme level based on the allocated power so that the amount of data approximate to the amount of requested data is allocated.

5. The method of claim 1, wherein the determining of the subchannel comprises determining a subchannel having the most superior channel state from among subchannels not yet allocated as a subchannel for the equipment of each user, based on the channel state of the equipment of each user, following a sequence of the equipment of each user having the smallest ratio of the allocated amount of data to requested amount of data.

6. An apparatus for allocating a subchannel and forming a stationary beam to maximize transmission efficiency in an OFDMA based wireless communication system, the apparatus comprising:
a subchannel determining unit determining a subchannel for the equipment of each user, based on a channel state of the equipment of each user;
a beam index determining unit determining a beam index for the equipment of each user, based on location information and direction of arrival information of the equipment of each user;
an OFDM symbol generating unit generating an OFDM symbol by mapping a modulation symbol corresponding to the equipment of each user to the determined subchannel; and
an OFDM symbol transmitting unit transmitting the generated OFDM symbol to a wireless space by forming a beam following the determined beam index.

7. The apparatus of claim 6, further comprising a parameter determining unit calculating a predicted received signal to interference noise ratio of the equipment of each user, based on the channel state of the determined subchannel and the determined beam index and determining a modulation and coding scheme level for the equipment of each user based on the calculated predicted received signal to interference noise ratio,
wherein the OFDM symbol generating unit performs modulation and coding based on the determined modulation and coding scheme level.

8. The apparatus of claim 6, further comprising a parameter determining unit calculating the predicted received signal to interference noise ratio of the equipment of each user, based on the channel state of the determined subchannel and the determined beam index and determining a modulation and coding scheme level and allocated power of the equipment of each user, based on the calculated predicted received signal to interference noise ratio,
wherein the OFDM symbol generating unit performs modulation and coding based on the determined modulation and coding scheme level and regulates a size value of each modulation symbol based on the determined allocated power.

9. The apparatus of claim 6, wherein the subchannel determining unit determines a subchannel having the most superior channel state from among subchannels not yet allocated as a subchannel for the equipment of each user, based on the channel state of the equipment of each user, following a sequence of the equipment of each user having the smallest ratio of an amount of allocated data to amount of requested data.

10. A computer readable recording medium recording a program that executes the method of any one of claims 1 through 5.
